(19) United States
(12) Patent Application Publication
(10) Pub. No.: US 2014/0251605 A1
(43) Pub. Date: Sep. 11, 2014

(54) DEFOAMING COMPOSITIONS AND METHODS FOR GAS WELL TREATMENT

(71) Applicant: ECOLAB USA INC., Naperville, IL (US)

(72) Inventor: John Hera, Sugar Land, TX (US)

(73) Assignee: ECOLAB USA INC., Naperville, IL (US)

(21) Appl. No.: 13/867,858

(22) Filed: Apr. 22, 2013

Related U.S. Application Data
(60) Provisional application No. 61/774,278, filed on Mar. 7, 2013.

(51) Int. Cl. B01D 19/04

(52) U.S. Cl. CPC B01D 19/0404
USPC 166/265; 166/300; 516/132

(57) ABSTRACT

The present invention is directed to the use of non-silicon containing alcohol compositions that are capable of breaking a foam and preventing the formation of a foam for application to industries such as oil/gas extraction, production and refining.

### CROSS-REFERENCE TO RELATED APPLICATIONS

This application claims priority to U.S. Provisional Patent Application No. 61/774,278, filed on Mar. 7, 2013, the disclosure of which is hereby incorporated by reference in its entirety.

### FIELD OF THE INVENTION

The present invention relates to the development and use of a silicone-free defoamer/antifoam (D/A) agent for application in industries such as oil/gas extraction, production and refining.

### BACKGROUND OF THE INVENTION

In most gas wells, water and/or condensate oil is produced along with gas. A decrease in gas production can be an indicator that liquid has collected in the well or pipeline. Accumulated liquids cause hydrostatic pressure on the reservoir. This pressure can result in the reduction of transportation energy, thereby affecting the gas production capacity. Accordingly, additional energy is generally required to lift the liquid and remove it from the well.

Foaming agents are commonly used in methods to reduce the density of the liquid so it can be removed from the well with the gas flow. The purpose of the foaming agent is to generate foam to lift (unload) the liquids from the well and decrease or eliminate hydrostatic backpressure to allow gas flow. This decrease in backpressure increases gas production and further enhances the foaming action and the well unloading.

The resultant foam is typically broken with the addition of an effective amount of a defoamer to recover the fluid. Gas/oil well unloading methods often include repeating the addition of foam forming agents or foam to the well, the production and lifting of foam, and the breaking of the foam over a set period of time or a set number of foaming/defoaming cycles. Also, it is desired that the defoamer be effective as an antifoam, to minimize or eliminate re-foaming of the unloaded fluid going to separators, storage containers, etc. While silicone-based defoamers are often used, silicone does not degrade in the environment and silicones are known to foul catalysts in refineries. Accordingly, a silicon-free, environmentally safe defoamer/antifoam (D/A) is desired. Also, a silicon-free D/A, with no hydrophilic silica is desired.

### SUMMARY OF INVENTION

The present invention is directed to a method for defoaming a foam comprising contacting the foam with an effective amount of a composition comprising a compound having the following formula:

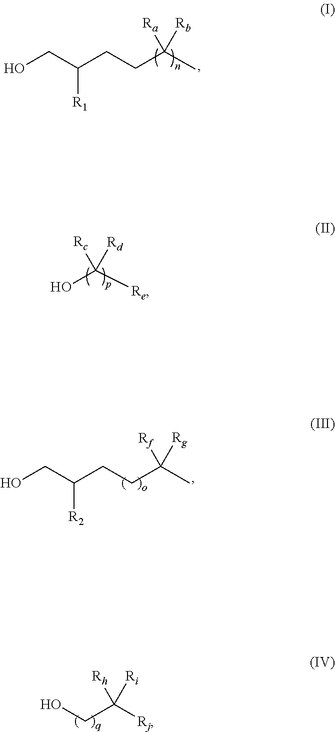

a mixture thereof, a blend thereof or a salt thereof,

R₁ and R₂ are each independently selected from the group consisting of hydrogen and alkyl;

Rₐ, R_{b}, R_{f} and R_{g}, at each occurrence, are each independently selected from the group consisting of hydrogen and alkyl;

R_{c}, R_{d}, Rₕ and Rᵢ, at each occurrence, are each independently selected from the group consisting of hydrogen and methyl;

Rₑ and Rⱼ are hydrogen;

n and o are each independently 1, 2, 3, 4, 5, 6, 7, 8, 9, 10, 11, 12, 13, 14, or 15;

p is 1, 2, 3, or 4; and

q is 0, 1, 2, or 3.

The D/A composition does not contain silicon. The composition is contacted with the foam at the surface and injected into the foam. The composition may comprise 2-ethylhexanol, decanol, or a mixture thereof. The composition may comprise a mixture of about 95 wt % 2-ethylhexanol and about 5 wt % 1-octadecanol.

The present invention is also directed to a method for inhibiting formation of a foam in an aqueous solution comprising contacting the foam with an effective amount of a composition comprising a compound having the following formula:

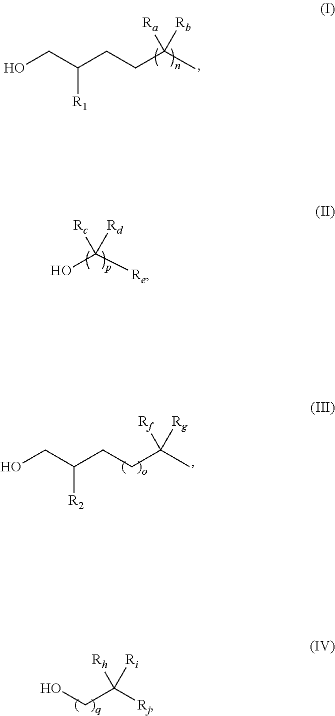

a mixture thereof, a blend thereof or a salt thereof, wherein

R₁ and R₂ are each independently selected from the group consisting of hydrogen and alkyl;

Rₐ, R_{b}, R_{f} and R_{g}, at each occurrence, are each independently selected from the group consisting of hydrogen and alkyl;

Rₑ, R_{d}, Rₕ and Rᵢ, at each occurrence, are each independently selected from the group consisting of hydrogen and methyl;

Rₑ and Rⱼ are hydrogen;

n and o are each independently 1, 2, 3, 4, 5, 6, 7, 8, 9, 10, 11, 12, 13, 14, or 15;

p is 1, 2, 3, or 4; and

q is 0, 1, 2, or 3,

wherein the composition is free of silicon. The composition is contacted with the foam at the surface and injected into the foam. The composition may comprise 2-ethylhexanol, decanol, or a mixture thereof. The composition may comprise a mixture of about 95 wt % 2-ethylhexanol and about 5 wt % 1-octadecanol.

The present invention is also directed to a method for relieving or preventing liquid backpressure in a well or pipeline comprising (a) injecting into a well or pipeline, a foam-forming composition, and optionally a gas, to produce a foam; (b) bringing the foam to a surface of the well or pipeline; and (c) contacting the foam with an effective amount of a defoaming composition comprising a compound having the following formula:

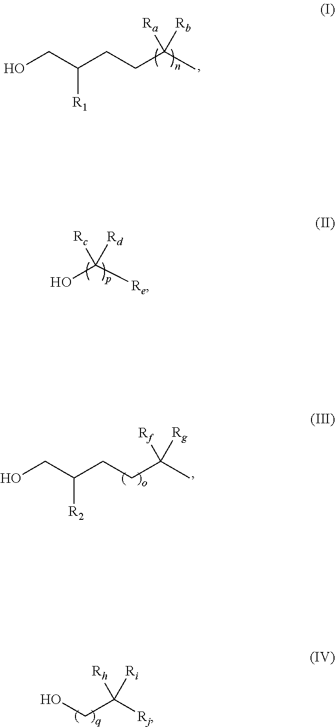

a mixture thereof, a blend thereof or a salt thereof, wherein

R₁ and R₂ are each independently selected from the group consisting of hydrogen and alkyl;

Rₐ, R_{b}, R_{f} and R_{g}, at each occurrence, are each independently selected from the group consisting of hydrogen and alkyl;

Rₑ, R_{d}, Rₕ and Rᵢ, at each occurrence, are each independently selected from the group consisting of hydrogen and methyl;

Rₑ and Rⱼ are hydrogen;

n and o are each independently 1, 2, 3, 4, 5, 6, 7, 8, 9, 10, 11, 12, 13, 14, or 15;

p is 1, 2, 3, or 4; and

q is 0, 1, 2, or 3,

wherein the defoaming composition breaks the foam from a well or pipeline during well unloading.

The method further comprises separating water from oil in the broken foam, separating contaminant from gas and/or oil in the broken foam, contacting at the surface of the foam, or injecting into the foam. The defoaming composition may comprise 2-ethylhexanol, decanol, or a mixture thereof. The defoaming composition may comprise a mixture of about 95 wt % 2-ethylhexanol and about 5 wt % 1-octadecanol.

### BRIEF DESCRIPTION OF THE DRAWINGS

FIG. 1 shows defoamer and antifoam (D/A) testing of a herein described non-silicone defoamer/antifoam, 2-ethylhexanol. (A) No defoamer. (B) Immediately after addition of 2-ethylhexanol. (C) Less than 1 minute after addition of 2-ethylhexanol. (D) After re-agitation. Foam collapse occurred within seconds after addition of 2-ethylhexanol. See date/time stamp on each of (A)-(D).

FIG. 2 shows foaming tendency tests for a composition including no defoamer/antifoam (blank): (A) initial blank; (B) Blank at 10 minutes; and (C) Blank at 15 minutes.

FIG. 3 shows foaming tendency tests for a composition including no defoamer/antifoam (blank): (A) initial blank; and (B) Blank at 10 minutes.

FIG. 4 shows defoamer testing of 5000 ppm 2-ethylhexanol: (A) initial blank; (B) at 1 minute 22 seconds after addition; and (C) at 2 minutes after addition.

FIG. 5 shows antifoam/refoam tests of 5000 ppm 2-ethylhexanol: (A) 1 minute sparging during refoaming; (B) 2 minutes sparging during refoaming; (C) refoamed sample at 5 minutes sparging; and (D) refoamed sample 5 minutes sparging, collapse time less than 6 seconds.

FIG. 6 shows defoamer testing of 5000 ppm isopropyl alcohol: (A) initial blank; (B) at 1 minute after addition; and (C) at 5 minutes after addition.

FIG. 7 shows antifoam/refoam tests of 5000 ppm isopropyl alcohol: (A) 40 seconds after sparging; (B) 5 minutes after sparging; (C) 10 minutes after sparging; and (D) 15 minutes after sparging.

FIG. 8 shows defoamer testing of 5000 ppm decyl alcohol: (A) initial blank; (B) at 2 minutes after addition; and (C) at 4 minutes after addition.

FIG. 9 shows antifoam/refoam tests of 5000 ppm decyl alcohol: (A) refoamed sample at 1 minute sparging; (B) refoamed sample at 5 minutes sparging; and (C) refoamed sample collapse time of less than 7 seconds.

FIG. 10 shows defoamer testing of 5000 ppm of a mixture of 2-ethylhexanol+5 wt % 1-octadecanol: (A) initial blank; (B) at 2 minutes after addition; and (C) at 2 minutes 47 seconds after addition.

FIG. 11 shows antifoam/refoam tests of 5000 ppm of a mixture of 2-ethylhexanol+5 wt % 1-octadecanol: (A) refoamed sample at 1 minute sparging; (B) refoamed sample at 5 minutes sparging; and (C) refoamed sample collapse time of less than 3 seconds.

FIG. 12 shows defoamer testing of 5000 ppm of a 50/50 wt/wt mixture of 2-ethylhexanol and decyl alcohol: (A) initial blank; and (B) at 2 minutes after addition.

FIG. 13 shows antifoam/refoam tests of 5000 ppm of a 50/50 wt/wt mixture of 2-ethylhexanol and decyl alcohol: (A) refoamed sample at 1 minute sparging; (B) refoamed sample at 5 minutes sparging; and (C) refoamed sample collapse time of less than 5 seconds.

### DETAILED DESCRIPTION

Described herein are chemical defoamers, for breaking existing foam and antifoams for preventing the formation of foam. The inventors have discovered that certain non-silicone containing alcohols are effective defoamer/antifoam compositions (D/A compositions) and environmentally safe.

In most gas wells, water and/or condensate oil is produced along with gas. Liquid backpressure in an oil or gas well or pipeline can result in significantly decreased production. For example, in mature gas wells, decreasing formation pressures and gas velocities gradually cause the wells to become “loaded” with water and/or crude oil condensate liquids. Because of the difficulties in unloading liquid-loaded wells with higher water and condensate cuts, operators may use a variety of methods to prevent liquid loading in marginal gas wells. These methods include the application of chemical foaming agents (foamers).

Foaming agents form a low density foam column when properly mixed with water or brine with even a small amount of agitation from gas flow. This lightened column is lifted from the well by gas pressure that is too low to lift a column of water. The foam formed by the foaming agent and water also lifts the foamed water and condensate oil from the well, eliminating backpressure. Furthermore, the foam is rigid and, by capturing gas in the form of bubbles, the gas is prevented from bypassing water in well casings.

The use of foamers to remove water can be problematic, however, as the presence of foam can interfere with the separation of gas from water and oil during production. The herein described environmental friendly D/A compositions are capable of not only breaking the foam formed, but also minimizing or preventing re-foaming of the water, thereby providing significant aid to the recovery of oil and gas from wells and pipelines affected by the accumulation of water together with condensate.

### 1. DEFINITIONS

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “and” and “the” include plural references unless the context clearly dictates otherwise. The present disclosure also contemplates other embodiments “comprising,” “consisting of” and “consisting essentially of,” the embodiments or elements presented herein, whether explicitly set forth or not.

The term “alkyl,” as used herein, refers to a linear or branched paraffinic hydrocarbon group, preferably having 1, 2, 3, 4, 5, 6, 7, 8, 9, 10, 11, 12, 13, 14, 15, 16, 17, 18, 19, 20, 21, 22, 23, 24, 25, 26, 27, 28, 39, 30, 31, or 32 carbons. Alkyl groups include, but are not limited to, methyl, ethyl, n-propyl, isopropyl, n-butyl, iso-butyl, sec-butyl, and tert-butyl. Alkyl groups may be unsubstituted or substituted by one or more suitable substituents, as defined below.

The term “hydroxy,” as used herein, refers to an —OH group.

The term “substituent,” as used herein, is intended to mean a chemically acceptable functional group that is “substituted” at any suitable atom of that group. Suitable substituents include, but are not limited to alkyl groups, alkenyl groups, alkynyl groups, hydroxy groups, oxo groups, alkoxy groups, aryl or heteroaryl groups, aryloxy or heteroaryloxy groups, aralkyl or heteroaralkyl groups, HO—(C═O)— groups, heterocylic groups, cycloalkyl groups, amino groups, alkyl- and dialkylamino groups, carbamoyl groups, alkylcarbonyl groups, alkoxycarbonyl groups, alkylaminocarbonyl groups, dialkylamino carbonyl groups, arylcarbonyl groups, aryloxycarbonyl groups, alkylsulfonyl groups, arylsulfonyl groups, groups of formula —(OCH₂)ₜOH wherein t is 1 to 25, and groups of formula alkylenyl-(OCH₂)ₜOH wherein t is 1 to 25. Those skilled in the art will appreciate that many substituents can be substituted with additional substituents.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

### 2. DEFOAMER/ANTIFOAM COMPOSITION (D/A COMPOSITION)

The present invention is directed to the use of a D/A composition that is capable of breaking pre-existing foam (defoamer) and also hindering or preventing foam re-formation (antifoam). Accordingly, the D/A composition possess both defoamer and antifoam functional characteristics. The D/A composition may break pre-existing foam (defoamer) and prevent refoaming (antifoam) at a treating rate of 5000 parts per million (ppm) (volume to volume) or less based on water, with the use of a foaming agent used at 5000 ppm, also based on water.

The D/A composition is environmentally safe. For example, the D/A composition is biodegradable and does not contain silicone. The D/A composition may be flammable or non-flammable. The D/A composition may comprise an effective amount of a compound having the following formula:

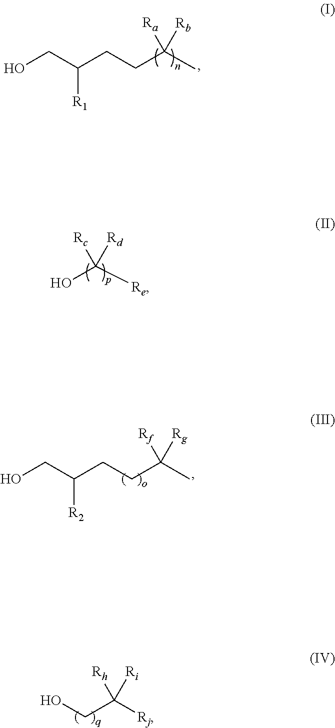

a mixture thereof, a blend thereof or a salt thereof, wherein

R₁ and R₂ are each independently selected from the group consisting of hydrogen and alkyl;

Rₐ, R_{b}, R_{f} and R_{g}, at each occurrence, are each independently selected from the group consisting of hydrogen and alkyl;

Rₑ, R_{d}, Rₕ and Rᵢ, at each occurrence, are each independently selected from the group consisting of hydrogen and methyl;

Rₑ and Rⱼ are hydrogen;

n and o are each independently 1, 2, 3, 4, 5, 6, 7, 8, 9, 10, 11, 12, 13, 14, or 15;

p is 1, 2, 3, or 4; and

q is 0, 1, 2, or 3.

A mixture or blend, as defined herein, may comprise two or more compounds of formula (I), two or more compounds of formula (II), two or more compounds of formula (III), two or more compounds of formula (IV), one or more compounds of formula (I) or formula (III) and one or more compounds of formula (II) or formula (IV). A mixture or blend of the compounds may be a mixture including C₉-C₁₁ alcohols or C₈-C₁₈ alcohols, with lower molecular weight alcohols, for example, isopropyl alcohol or butanol. Another mixture or blend C₉-C₁₁-ISO, and C₁₀-rich.

The D/A composition may have a low pour point. The pour point of a liquid is the lowest temperature at which it maintains the ability to flow. The ability of the D/A composition to flow at low temperature may be measured by any one of a variety of methods including ASTM D97 (Standard Test Method for Pour Point of Petroleum Products), ASTM D1015 (Standard Test method for Freezing Points of High-Purity Hydrocarbons), viscosity measurements, melting point measurements, etc. The D/A composition may have a pour point of less than or equal to −5° C., less than or equal to −10° C., less than or equal to −15° C., less than or equal to −25° C., less than or equal to −35° C., less than or equal to −40° C., or less than or equal to −45° C. The D/A composition may further have a low viscosity from 5 cp, 6 cp, 7 cp, 8 cp, 9 cp, 10 cp, 11 cp, 12 cp, 13 cp, 14 cp, 15 cp, 16 cp, 17 cp, 18 cp, 19 cp, 20 cp, 21 cp, 22 cp, 23 cp, 24 cp, 25 cp, 26 cp, 27 cp, 28 cp, 29 cp, 30 cp, 31 cp, 32 cp, 33 cp, 34 cp, 35 cp, 36 cp, 37 cp, 38 cp, 39 cp, 40 cp, 41 cp, 42 cp, 43 cp, 44 cp, 45 cp, 46 cp, 47 cp, 48 cp, 49 cp, or 50 cp at 20° C. and 95 cp, 96 cp, 97 cp, 98 cp, 99 cp, 100 cp, 101 cp, 102 cp, 103 cp, 104 cp, 105 cp, 106 cp, 107 cp, 108 cp, 109 cp, 110 cp, 111 cp, 112 cp, 113 cp, 114 cp, 115 cp, 116 cp, 117 cp, 118 cp, 119 cp, 120 cp, 121 cp, 122 cp, 123 cp, 124 cp, 125 cp, 130 cp, 140 cp, 150 cp, 160 cp, 170 cp, 180 cp, 190 cp, 200 cp, 210 cp, 220 cp, 230 cp, 240 cp, 250 cp, 260 cp, 270 cp, 280 cp, 290 cp, 300 cp, 310 cp, 320 cp, 330 cp, 340 cp, 350 cp, 360 cp, 370 cp, 380 cp, 390 cp, 400 cp, 410 cp, 420 cp, 430 cp, 440 cp, 450 cp, 460 cp, 470 cp, 480 cp, 490 cp, 500 cp, 510 cp, 520 cp, 530 cp, 540 cp, 550 cp, 560 cp, 570 cp, 580 cp, 590 cp, or 600 cp at −20° C.

The D/A composition may have a flash point of greater than or equal to 10° C., greater than or equal to 15° C., greater than or equal to 20° C., greater than or equal to 25° C., greater than or equal to 30° C., greater than or equal to 35° C., greater than or equal to 40° C., greater than or equal to 45° C., greater than or equal to 50° C., greater than or equal to 55° C., greater than or equal to 60° C., greater than or equal to 65° C., greater than or equal to 70° C., greater than or equal to 75° C., greater than or equal to 80° C., greater than or equal to 85° C., greater than or equal to 90° C., greater than or equal to 95° C., greater than or equal to 100° C., greater than or equal to 105° C., greater than or equal to 110° C., greater than or equal to 115° C., or greater than or equal to 120° C.

a. Non-Flammable Compounds of the D/A Composition

The D/A composition may comprise the compound of formula (I) or formula (III). The compound of formula (I) or formula (III) is non-flammable. The compound of formula (I) or formula (III) may be 2-ethylhexanol, a C₈-C₁₈ alcohol, or a C₉-C₁₁ alcohol. The compound of formula (I) or formula (III) may be a higher molecular weight alcohol or mixture of higher molecular weight alcohols that are effective defoamers/antifoams breaking pre-existing foam at adefoamer treating rate of 5000 parts per million (ppm) or less based on water, with the use a foaming agent used at 5000 ppm, also based on water.

b. Flammable Compounds of the D/A Composition

The D/A composition may comprise the compound of formula (II) or formula (IV) or mixtures thereof. The compound of formula (II) or formula (IV) may be flammable. The compound of formula (II) or formula (IV) may be methanol, isopropyl alcohol, and isobutanol. These compounds are effective defoamers/antifoams, but are flammable. The compounds of formula (II) or formula (IV) of the D/A composition may break pre-existing foam (defoamer) at a defoamer treating rate of 5000 ppm or less based on water, with the use of a foaming agent used at 5000 ppm, also based on water.

c. Mixtures or Blends of Compounds of Formula (I) and (II)

The D/A composition may comprise a mixture or blend of one or more compounds of formula (I) or formula (III) and one or more compounds of formula (II) or formula (IV). The blend may be flammable or non-flammable. The compounds of the blend are effective defoamers/antifoams breaking pre-existing foam at a defoamer treating rate of 5000 ppm or less based on water, with the use a foaming agent used at 5000 ppm, also based on water.

A blend may be necessary, for example, at low temperatures where higher molecular weight alcohol based defoamers/antifoams of formula (I) or formula (III) need to be diluted in a lower molecular weight alcohol or solvent of formula (II) or formula (IV) or mixtures thereof in order to reduce the high pour points and high viscosity at low temperatures of the compounds of formula (I) or formula (III). These blends allow for adjustments in different environments, such as low temperature.

### 3. FOAM-FORMING COMPOSITION

The D/A composition may be combined with a foam-forming composition. Among the various classes of foam-forming compositions are keratin compositions, nonionic compositions, anionic compositions, cationic compositions, and amphoteric compositions. The foam-forming composition may be aqueous or non-aqueous. The foam forming composition may be employed or used in a concentrate or dilute form. Water, which may be effectively employed herein for both forming and/or diluting the concentrate, may include water from any natural source, including a brine ranging in concentration of dissolved solids up to saturated brine depending on reservoir temperature and concentrate composition.

### 4. ADDITIONAL COMPONENTS FOR D/A COMPOSITION AND FOAM-FORMING COMPOSITION

The D/A composition and/or foam forming composition may further optionally include one or more additives. Suitable additives include, but are not limited to, solvents, corrosion inhibitors, scale inhibitors, emulsifiers, water clarifiers, dispersants, emulsion breakers, hydrogen sulfide scavengers, gas hydrate inhibitors, biocides, pH modifiers, surfactants, synergistic compounds, asphaltene inhibitors, paraffin inhibitors, and antioxidants.

(1) Solvents

The D/A composition and/or foam forming composition may further comprise one or more solvents. Suitable solvents include, but are not limited to, water, isopropanol, methanol, ethanol, 2-ethylhexanol, heavy aromatic naphtha, toluene, ethylene glycol, ethylene glycol monobutyl ether (EGMBE), diethylene glycol monoethyl ether, and xylene. Representative polar solvents suitable for formulation with the composition include water, brine, seawater, alcohols (including straight chain or branched aliphatic such as methanol, ethanol, propanol, isopropanol, butanol, 2-ethylhexanol, hexanol, octanol, decanol, 2-butoxyethanol, etc.), glycols and derivatives (ethylene glycol, 1,2-propylene glycol, 1,3-propylene glycol, ethylene glycol monobutyl ether, etc.), ketones (cyclohexanone, diisobutylketone), N-methylpyrrolidinone (NMP), N,N-dimethylformamide and the like. Representative non-polar solvents suitable for formulation with the composition include aliphatics such as pentane, hexane, cyclohexane, methylcyclohexane, heptane, decane, dodecane, diesel, and the like; aromatics such as toluene, xylene, heavy aromatic naphtha, fatty acid derivatives (acids, esters, amides), and the like.

In certain embodiments, the solvent is monoethyleneglycol, methanol, dimethyl sulfoxide (DMSO), dimethylformamide (DMF), tetrahydrofuran (THF), or a combination thereof.

In certain embodiments, a composition of the invention comprises from 0 to about 80 percent by weight of one or more solvents, based on the weight of the composition. In certain embodiments, a composition of the invention comprises from 0 to about 50 percent by weight of one or more solvents, based on the weight of the composition. In certain embodiments, a composition of the invention comprises 20%, 25%, 30%, 35%, 40%, 45%, or 50% by weight of one or more solvents, based on the weight of the composition.

(2) Corrosion Inhibitors

The D/A composition and/or foam forming composition may further comprise one or more corrosion inhibitors. Suitable corrosion inhibitors include, but are not limited to, amidoamines, quaternary amines, amides, and phosphate esters.

(3) Scale Inhibitors

The D/A composition and/or foam forming composition may further comprise one or more scale inhibitors. Suitable scale inhibitors include, but are not limited to, phosphates, phosphate esters, phosphoric acids, phosphonates, phosphonic acids, polyacrylamides, salts of acrylamido-methyl propane sulfonate/acrylic acid copolymer (AMPS/AA), phosphinated maleic copolymer (PHOS/MA), and salts of a polymaleic acid/acrylic acid/acrylamido-methyl propane sulfonate terpolymer (PMA/AMPS).

(4) Emulsifiers

The D/A composition and/or foam forming composition may further comprise one or more emulsifiers. Suitable emulsifiers include, but are not limited to, salts of carboxylic acids, products of acylation reactions between carboxylic acids or carboxylic anhydrides and amines, and alkyl, acyl and amide derivatives of saccharides (alkyl-saccharide emulsifiers).

(5) Water Clarifiers

The D/A composition and/or foam forming composition may further comprise one or more water clarifiers. Suitable water clarifiers include, but are not limited to, inorganic metal salts such as alum, aluminum chloride, and aluminum chlorohydrate, or organic polymers such as acrylic acid based polymers, acrylamide based polymers, polymerized amines, alkanolamines, thiocarbamates, and cationic polymers such as diallyldimethylammonium chloride (DADMAC).

(6) Dispersants

The D/A composition and/or foam forming composition may further comprise one or more dispersants. Suitable dispersants include, but are not limited to, aliphatic phosphonic acids with 2-50 carbons, such as hydroxyethyl diphosphonic acid, and aminoalkyl phosphonic acids, e.g. polyaminomethylene phosphonates with 2-10 N atoms e.g. each bearing at least one methylene phosphonic acid group; examples of the latter are ethylenediamine tetra(methylene phosphonate), diethylenetriamine penta(methylene phosphonate) and the triamine- and tetramine-polymethylene phosphonates with 2-4 methylene groups between each N atom, at least 2 of the numbers of methylene groups in each phosphonate being different. Other suitable dispersion agents include lignin or derivatives of lignin such as lignosulfonate and naphthalene sulfonic acid and derivatives.

(7) Emulsion Breakers

The D/A composition and/or foam forming composition may further comprise one or more emulsion breakers. Suitable emulsion breakers include, but are not limited to, dodecylbenzylsulfonic acid (DDBSA), the sodium salt of xylenesulfonic acid (NaXSA), epoxylated and propoxylated compounds, anionic cationic and nonionic surfactants, and resins, such as phenolic and epoxide resins.

(8) Hydrogen Sulfide Scavengers

The D/A composition and/or foam forming composition may further comprise one or more hydrogen sulfide scavengers. Suitable additional hydrogen sulfide scavengers include, but are not limited to, oxidants (e.g., inorganic peroxides such as sodium peroxide, or chlorine dioxide), aldehydes (e.g., of 1-10 carbons such as formaldehyde or glutaraldehyde or (meth)acrolein), triazines (e.g., monoethanol amine triazine, and monomethylamine (MMA) triazine), and glyoxal. In certain embodiments, blending the compounds and compositions of the invention with MMA triazines lowers or eliminates offensive MMA odors.

(9) Gas Hydrate Inhibitors

The D/A composition and/or foam forming composition may further comprise one or more gas hydrate inhibitors. Suitable gas hydrate inhibitors include, but are not limited to, thermodynamic inhibitors (THI), kinetic inhibitors (KHI), and anti-agglomerates (AA). Suitable thermodynamic inhibitors include, but are not limited to, NaCl salt, KCl salt, CaCl₂ salt, MgCl₂ salt, NaBr₂ salt, formate brines (e.g. potassium formate), polyols (such as glucose, sucrose, fructose, maltose, lactose, gluconate, monoethylene glycol, diethylene glycol, triethylene glycol, mono-propylene glycol, dipropylene glycol, tripropylene glycol, tetrapropylene glycol, monobutylene glycol, dibutylene glycol, tributylene glycol, glycerol, diglycerol, triglycerol, and sugar alcohols (e.g. sorbitol, mannitol), methanol, propanol, ethanol, glycol ethers (such as diethyleneglycol monomethyl ether, ethylene glycol monobutyl ether), and alkyl or cyclic esters of alcohols (such as ethyl lactate, butyl lactate, methylethyl benzoate). Suitable kinetic inhibitors and anti-agglomerates include, but are not limited to, polymers and copolymers, polysaccharides (such as hydroxy-ethylcellulose (HEC), carboxymethylcellulose (CMC), starch, starch derivatives, and xanthan), lactams (such as polyvinylcaprolactam, polyvinyl lactam), pyrrolidones (such as polyvinyl pyrrolidone of various molecular weights), surfactants (such as fatty acid salts, ethoxylated alcohols, propoxylated alcohols, sorbitan esters, ethoxylated sorbitan esters, polyglycerol esters of fatty acids, alkyl glucosides, alkyl polyglucosides, alkyl sulfates, alkyl sulfonates, alkyl ester sulfonates, alkyl aromatic sulfonates, alkyl betaine, alkyl amido betaines), hydrocarbon based dispersants (such as lignosulfonates, iminodisuccinates, polyaspartates), amino acids, and proteins.

(10) Biocides

The D/A composition and/or foam forming composition may further comprise one or more biocides. Any biocide suitable in oilfield operations may be used. A biocide may be included in a composition in an amount of about 0.1 parts per million (ppm) to about 1000 ppm, e.g., 0.1 ppm, 0.5 ppm, 1 ppm, 2 ppm, 3 ppm, 4 ppm, 5 ppm, 6 ppm, 7 ppm, 8 ppm, 9 ppm, 10 ppm, 20 ppm, 30 ppm, 40 ppm, 50 ppm, 60 ppm, 70 ppm, 80 ppm, 90 ppm, 100 ppm, 200 ppm, 300 ppm, 400 ppm, 500 ppm, 600 ppm, 700 ppm, 800 ppm, 900 ppm, or 1000 ppm.

Suitable biocides include, but are not limited to, oxidizing and non-oxidizing biocides. Suitable non-oxidizing biocides include, for example amine-type compounds (e.g., quaternary amine compounds and cocodiamine), halogenated compounds (e.g., bronopol and 2-2-dibromo-3-nitrilopropionamide (DBNPA)), sulfur compounds (e.g., isothiazolone, carbamates, and metronidazole), and quaternary phosphonium salts (e.g., tetrakis (hydroxymethyl) phosphonium sulfate (THPS)). Suitable oxidizing biocides include, for example, sodium hypochlorite, trichloroisocyanuric acids, dichloroisocyanuric acid, calcium hypochlorite, lithium hypochlorite, chlorinated hydantoins, stabilized sodium hypobromite, activated sodium bromide, brominated hydantoins, chlorine dioxide, ozone, and peroxides.

(11) pH Modifiers

The D/A composition and/or foam forming composition may further comprise one or more pH modifiers. Suitable pH modifiers include, but are not limited to, alkali hydroxides, alkali carbonates, alkali bicarbonates, alkaline earth metal hydroxides, alkaline earth metal carbonates, alkaline earth metal bicarbonates and mixtures or combinations thereof. Exemplary pH modifiers include NaOH, KOH, Ca(OH)₂, CaO, Na₂CO₃, KHCO₃, K₂CO₃, NaHCO₃, MgO, and Mg(OH)₂.

(12) Surfactants

The D/A composition and/or foam forming composition may further comprise one or more surfactants. The surfactant may be a cationic surfactant, an anionic surfactant, an amphoteric surfactant, a zwitterionic surfactant or a non-ionic surfactant. In some embodiments, a surfactant may aid in improving the recovery of oil from the formation. A surfactant may be included in a fluid in an amount of about 100 parts per million (ppm) to about 10000 ppm, e.g., 100 ppm, 200 ppm, 300 ppm, 400 ppm, 500 ppm, 600 ppm, 700 ppm, 800 ppm, 900 ppm, 1000 ppm, 2000 ppm, 3000 ppm, 4000 ppm, 5000 ppm, 6000 ppm, 7000 ppm, 8000 ppm, 9000 ppm, or 10000 ppm.

Suitable surfactants include, but are not limited to, anionic surfactants, cationic surfactants, and nonionic surfactants. Anionic surfactants include alkyl aryl sulfonates, olefin sulfonates, paraffin sulfonates, alcohol sulfates, alcohol ether sulfates, alkyl carboxylates and alkyl ether carboxylates, alkyl and ethoxylated alkyl phosphate esters, and mono- and di-alkyl sulfosuccinates and sulfosuccinamates. Suitable anionic surfactants include alkyl or alkyl ether sulfates and sulfonates, such as C₁₄-C₂₄ alpha olefin sulfonates, C₁₃-C₁₈ alcohol ether sulfates, C₁₅-C₁₇ internal olefin sulfonates, and C₁₂-C₁₈ ester sulfonates. Cationic surfactants include alkyl trimethyl quaternary ammonium salts, alkyl dimethyl benzyl quaternary ammonium salts, dialkyl dimethyl quaternary ammonium salts, and imidazolinium salts.

Nonionic surfactants include alcohol alkoxylates, alkylphenol alkoxylates, block copolymers of ethylene, propylene and butylene oxides, alkyl dimethyl amine oxides, alkyl-bis(2-hydroxyethyl) amine oxides, alkyl amidopropyl dimethyl amine oxides, alkylamidopropyl-bis(2-hydroxyethyl) amine oxides, alkyl polyglucosides, polyalkoxylated glycerides, sorbitan esters and polyalkoxylated sorbitan esters, and alkoyl polyethylene glycol esters and diesters. Also included are betaines and sultanes, amphoteric surfactants such as alkyl amphoacetates and amphodiacetates, alkyl amphopropionates and amphodipropionates, and alkyliminodipropionate.

(13) Synergistic Compounds

The D/A composition and/or foam forming composition may further comprise one or more synergistic compounds. Suitable synergistic compounds include compounds that enhance the hydrogen sulfide scavenging performance of the composition. In certain embodiments, the synergistic compound may be a quaternary ammonium compound, an amine oxide, an ionic or non-ionic surfactant, or any combination thereof. Suitable quaternary amine compounds include, but are not limited to, alkyl benzyl ammonium chloride, benzyl cocoalkyl(C₁₂-C₁₈)dimethylammonium chloride, dicocoalkyl (C₁₂-C₁₈)dimethylammonium chloride, ditallow dimethylammonium chloride, di(hydrogenated tallow alkyl)dimethyl quaternary ammonium methyl chloride, methyl bis(2-hydroxyethyl cocoalkyl(C₁₂-C₁₈) quaternary ammonium chloride, dimethyl(2-ethyl) tallow ammonium methyl sulfate, n-dodecylbenzyldimethylammonium chloride, n-octadecylbenzyldimethyl ammonium chloride, n-dodecyltrimethylammonium sulfate, soya alkyltrimethylammonium chloride, and hydrogenated tallow alkyl (2-ethylhyexyl) dimethyl quaternary ammonium methyl sulfate. Suitable amine oxide compounds include, but are not limited to, fatty amine oxides such as stearyl dimethylamine oxide, lauryldimethylamine oxide, and cocamidopropylamine oxide, or etheramine oxides such as bis-(2-hydroxyethyl)isodecyloxypropylamine oxide. Suitable nonionic surfactants include, but are not limited to, polyoxyethylene glycol alkyl ethers, polyoxypropyleneglycol alkyl ethers, polyoxyethyleneglycol nonylphenol ethers, poloxamers, cocamide diethanolamine, and polyethoxylated tallow amine

The synergist compound(s) may be present from about 0.01 to about 20 percent by weight. In certain embodiments, the synergistic compound is present from about 1 to about 10 percent by weight, from about 2 to about 9 percent by weight, from about 3 percent to about 8 percent by weight, from about 4 percent to about 7 percent by weight, or from about 5 percent to about 6 percent by weight. In certain embodiments, the synergist compound(s) may be added to a fluid or gas simultaneously with the fluid, or may be added separately.

(14) Asphaltene Inhibitors

The D/A composition and/or foam forming composition may further comprise one or more asphaltene inhibitors. Suitable asphaltene inhibitors include, but are not limited to, aliphatic sulfonic acids; alkyl aryl sulfonic acids; aryl sulfonates; lignosulfonates; alkylphenol/aldehyde resins and similar sulfonated resins; polyolefin esters; polyolefin imides; polyolefin esters with alkyl, alkylenephenyl or alkylenepyridyl functional groups; polyolefin amides; polyolefin amides with alkyl, alkylenephenyl or alkylenepyridyl functional groups; polyolefin imides with alkyl, alkylenephenyl or alkylenepyridyl functional groups; alkenyl/vinyl pyrrolidone copolymers; graft polymers of polyolefins with maleic anhydride or vinyl imidazole; hyperbranched polyester amides; polyalkoxylated asphaltenes, amphoteric fatty acids, salts of alkyl succinates, sorbitan monooleate, and polyisobutylene succinic anhydride.

(15) Paraffin Inhibitors

The D/A composition and/or foam forming composition may further comprise one or more paraffin inhibitors. Suitable paraffin inhibitors include, but are not limited to, paraffin crystal modifiers, and dispersant/crystal modifier combinations. Suitable paraffin crystal modifiers include, but are not limited to, alkyl acrylate copolymers, alkyl acrylate vinylpyridine copolymers, ethylene vinyl acetate copolymers, maleic anhydride ester copolymers, branched polyethylenes, naphthalene, anthracene, microcrystalline wax and/or asphaltenes. Suitable dispersants include, but are not limited to, dodecyl benzene sulfonate, oxyalkylated alkylphenols, and oxyalkylated alkylphenolic resins.

(16) Antioxidants

In some embodiments, the D/A composition and/or foam forming composition may further comprise one or more antioxidants. Any antioxidant suitable in oilfield operations may be used. Exemplary antioxidants include but are not limited to sulfites, thiocyanates and thiosulfates. An antioxidant may be included in a composition in an amount of about 1 parts per million (ppm) to about 1000 ppm, e.g., 1 ppm, 2 ppm, 3 ppm, 4 ppm, 5 ppm, 6 ppm, 7 ppm, 8 ppm, 9 ppm, 10 ppm, 20 ppm, 30 ppm, 40 ppm, 50 ppm, 60 ppm, 70 ppm, 80 ppm, 90 ppm, 100 ppm, 200 ppm, 300 ppm, 400 ppm, 500 ppm, 600 ppm, 700 ppm, 800 ppm, 900 ppm, or 1000 ppm.

### 5. METHOD FOR DEFOAMING A FOAM AND/OR INHIBITING FOAM FORMATION

The present invention is also directed to a method for defoaming a foam and/or inhibiting foam formation. An effective amount of the defoamer/antifoam (D/A) composition may be brought into contact with a foam or an aqueous solution, which is capable of forming a foam. The D/A composition may be contacted with the foam on the foam surface, injected into the foam, contacted with the aqueous solution on the solution surface, and/or injected into the solution.

The effective amount of the D/A composition will be sufficient to either break pre-formed foam or inhibit foam formation in a solution. The D/A composition may be contacted with the foam or solution at a typical treating rate of from 500 parts per million (ppm) (volume to volume) to 5000 ppm based on water. The D/A composition may be contacted with the foam or solution at a typical treatment rate of 500 ppm, 1000 ppm, 1500 ppm, 2000 ppm, 2500 ppm, 3000 ppm, 3500 ppm, 4000 ppm, 4500 ppm, or 5000 ppm based on water. The D/A composition may break a pre-existing foam (defoamer) in less than 15 minutes, 14 minutes, 13 minutes, 12 minutes, 11 minutes, 10 minutes, 9 minutes, 8 minutes, 7 minutes, 6 minutes, 5 minutes, 4 minutes, 3 minutes, 2 minutes, 1 minute, 55 seconds, 50 seconds, 45 seconds, 40 seconds, 35 seconds, 30 seconds, 25 seconds, or 20 seconds at an antifoam treating rate of 500 ppm, 1000 ppm, 1500 ppm, 2000 ppm, 2500 ppm, 3000 ppm, 3500 ppm, 4000 ppm, 4500 ppm, or 5000 ppm based on water, with the use of a foaming agent used at 500 ppm, 1000 ppm, 1500 ppm, 2000 ppm, 2500 ppm, 3000 ppm, 3500 ppm, 4000 ppm, 4500 ppm, or 5000 ppm, also based on water.

### 6. METHOD FOR RELIEVING OR PREVENTING LIQUID BACK-PRESSURE

The present invention is also directed to a method for relieving or preventing liquid backpressure in, for example, an oil or gas well or pipeline. The method may include the steps of injecting into a well or pipeline a foam or a foam-forming composition and, optionally, a gas, to produce a foam. The foam may be injected in an amount sufficient to reduce hydrostatic pressure of, for example, water and condensate, to a pressure at or below a hydrostatic pressure of a formation into which the well or pipeline is being drilled. The foam may then be brought to the surface of the well or pipeline, whereby it is contacted with an effective amount of the D/A composition, thereby breaking the foam. The injection point for the D/A on one typical offshore production platform not using a capillary string for foamer injection, is into the high-pressure separator, or test separator if in use. The D/A is injected during flowback of batch foamer treatments. When a capillary string injection system for the foamer is installed, D/A will be injected continuously on this application.

In a second application, foam is injected downhole via a capillary string. D/A is injected into a wellhead flowline or a production header.

The D/A composition may be contacted with the foam on the foam surface or injected into the foam. The foam at the surface of the well or pipeline may contain water, oil, gas, pebbles, rocks, and sand. After the foam is broken, the water, oil, gas, pebbles, rocks, and sand may be separated from one another.

It is understood that the foregoing detailed description and accompanying examples are merely illustrative and are not to be taken as limitations upon the scope of the invention, which is defined solely by the appended claims and their equivalents.

Various changes and modifications to the disclosed embodiments will be apparent to those skilled in the art. Such changes and modifications, including without limitation those relating to the chemical structures, substituents, derivatives, intermediates, syntheses, compositions, formulations, or methods of use of the invention, may be made without departing from the spirit and scope thereof.

### EXAMPLES

### Example 1

### Defoaming/Antifoam Capability of 2-Ethylhexanol by a Shake Test Method

A 2-ethylhexanol defoamer/antifoam(D/A) agent was tested for effectiveness in breaking stable foams created by mixing brine, condensate oil, and a foaming agent in a test container environment used to simulate foam lift for deliquification of gas well liquids to allow gas flow. 200 mL of water, 10 mL of condensate, 0.7 mL of foamer active were added to a 1-liter graduated bottle and shaken on high speed for 2 minutes on an Eberbach reciprocating shaker. The pour point of 2-ethylhexanol is −70° C. The viscosity of 2-ethylhexanol is 10.3 cP at 20° C. and was measured as 102.6 cP at −20° C. The freeze point on 2-ethylhexanol is −70° C.

The foamer active used is in this testing is a blend of alkyl betaines. The D/A was added to the top of the foam. Collapse by volume is measured over 1 minute in a graduated glass bottle to measure the rate of foam collapse over time. Testing on brine/condensate and 5000 ppm of the alkyl betaine foamer showed good performance on 2-ethylhexanol as a defoamer (data not shown). Foam collapse was measured as foam volume vs. time with no foam required one minute after adding the defoamer.

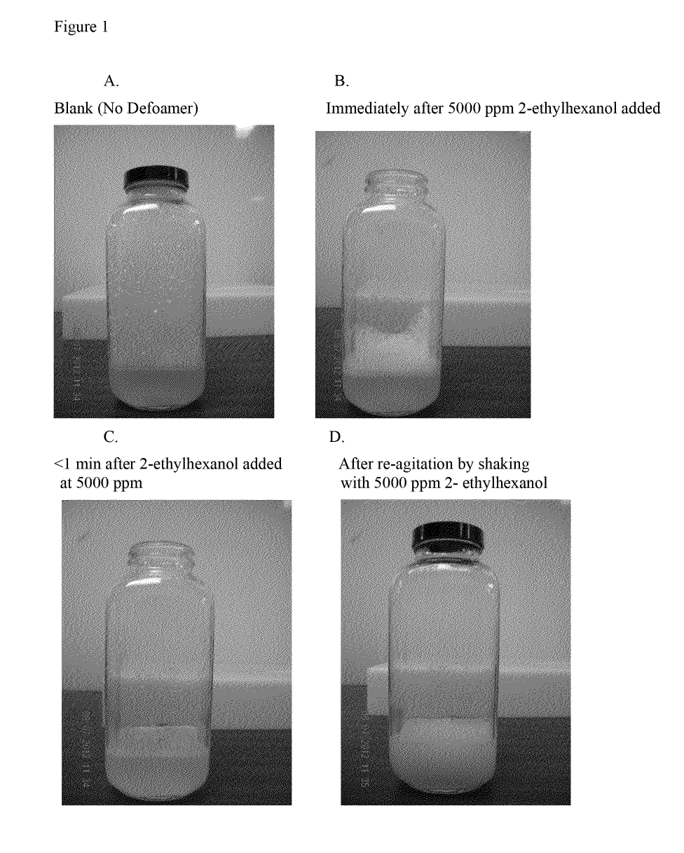

Following foam collapse, the sample was re-shaken by 100 hand shakes to test for re-foaming Water, condensate (oil), and a chemical foamer mixture were used to produce a stable foam. The D/A composition of 2-ethylhexanol broke this foam in less than one minute at an antifoam treating rate of 5000 ppm. The collapse time on the foam without D/A added, did not meet this one minute or less foam collapse time requirement. See FIG. 1A-D. The results indicate that 2-ethylhexanol is an effective foam breaker. For this application, the customer's maximum permissible defoamer treating rate is 5000 ppm based on the water volume. No foam at less than 1 minute after defoamer/antifoam addition was seen with the use of 5000 ppm 2-ethylhexanol. A test for re-foaming (antifoam function) immediately after foam collapse showed no tendency to refoam.

### Example 2

### Defoaming/Antifoam Capability of 2-Ethylhexanol and Other Alcohols by a Sparge Test Method

Additional testing was done with alcohol-based D/A compositions with the modified ASTM D892 test method described below.

The following procedure was used to measure foaming tendencies of blank samples containing foamer but no D/A composition:
1. One length of flexible tubing was connected to an ACE Glass Pour D gas dispersion tube and the other end to a gas flowmeter. The gas flowmeter was then connected to a regulated, low-pressure gas (nitrogen) source.
2. The gas flow rate was adjusted to 725 mL/min.
3. To a 1000 mL graduated cylinder, 100 mL brine, 5 mL of condensate oil, and 5000 ppm foaming agent were added. A blend of alkyl betaines was the foaming agent (foamer) used in this testing.
4. The graduated cylinder was gently swirled forty times to mix the contents, then simultaneously, the gas dispersion tube was inserted into the liquid in the cylinder and measuring the foam volume over time was started. The sparge tube was removed when the foam volume became too high, to prevent foam reaching the top of the sparge tube (approximately the 700 mL level on the graduated cylinder) and flowing out.
5. When the highest foam volume was reached (or before the sparge tube was completely covered by foam) simultaneously, the sparge tube was removed from the sample in the graduated cylinder and a timer was started to measure the foam collapse time. The foam collapse time is the time required for the foam column to collapse and half surface of the liquid to be free of foam.

The following procedure was used to measure effectiveness of D/A compositions on a brine/condensate sample containing a foamer blend of alkyl betaines:
1. 100 mL brine, 5 mL of condensate oil, and 5000 ppm foamer chemical was added into the 1000 mL graduated cylinder.
2. The graduated cylinder was gently swirled forty times to mix the contents, then simultaneously the gas dispersion tube was inserted (nitrogen flow rate 725 mL/min) into the liquid in the cylinder and measurements on the foam volume were started. To prevent the foam volume on a sample containing chemical foamer to reach reach too high a level and foaming over from the graduated cylinder, the spare tube was removed from the graduated cylinder after the liquid plus foam volume reached 350 mL (approximately 3.5 times the initial liquid volume).
3. The foam was then allowed to collapse to the 300 mL level. Then the defoamer/antifoam was added to the liquid in the graduated cylinder using a syringe or microliter pipette, and simultaneously the timer was started to measure the foam collapse time. The foam collapse time is the time required for the foam column to collapse and half the surface of the liquid to be free of foam.

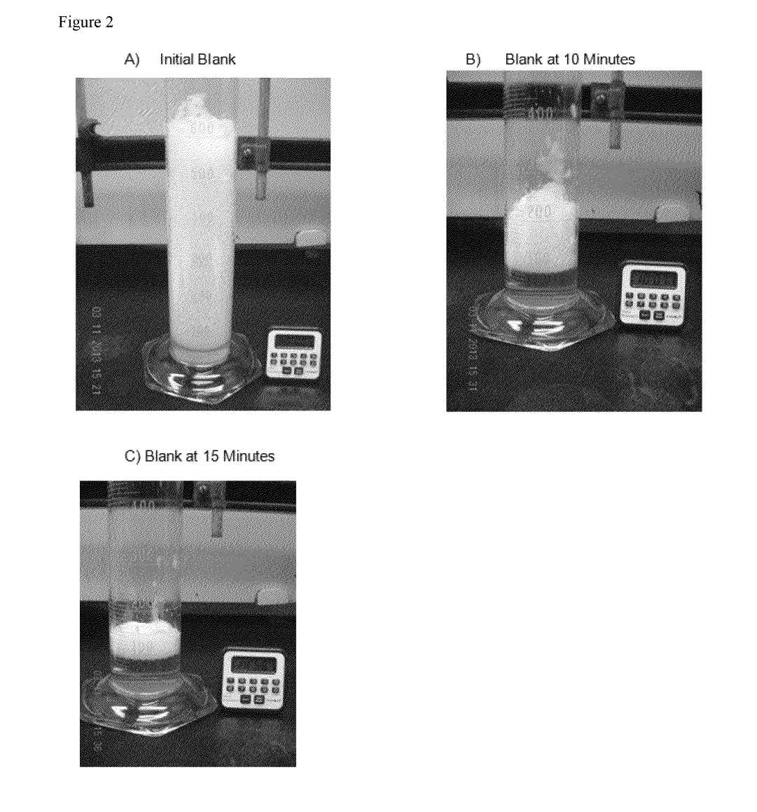

Foaming tendency testing on the alkyl betaine foamer and defoamer/antifoam tests on 2-ethylhexanol (defoamer/antifoam) added at 5000 ppm are shown in FIGS. 2-13 and in the tables below. Also shown are defoamer/antifoam tests on different alcohols and alcohol blends.

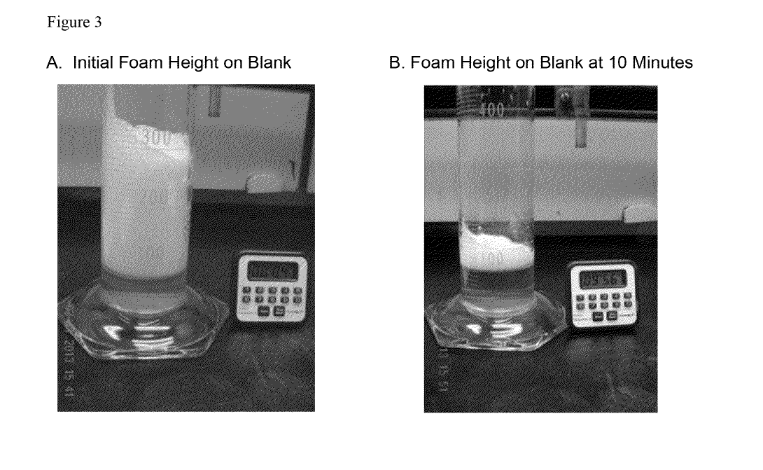

FIG. 2 shows results of a foaming tendency test using 100 mL brine, 5 mL condensate oil, and 500 ppm alkyl betaine foamer, with no defoamer/antifoam added (blank) at an initial time (A), after 10 minutes (B), and after 15 minutes (C). FIG. 3 shows results of a foaming tendency test using 100 mL brine, 5 mL condensate oil, and 500 ppm alkyl betaine foamer, foamed to 300 mL initial liquid+foam height, with no defoamer/antifoam added (blank) at an initial time (A) and after 10 minutes (B).

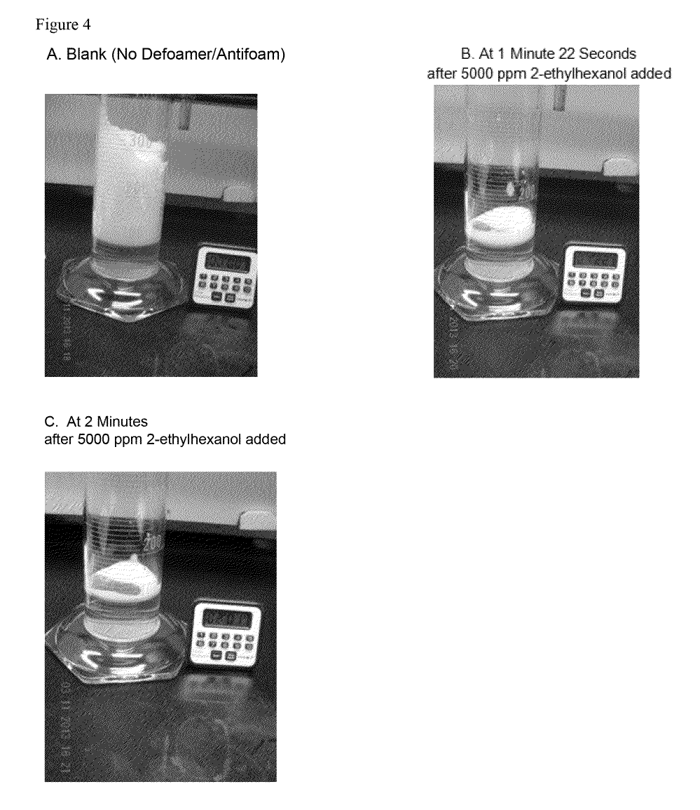

FIG. 4 shows results of the defoamer test using 100 mL brine, 5 mL condensate oil, and 5000 ppm alkyl betaine foamer at 300 mL initial liquid+foam height, at an initial time (A), after 1 minute 22 seconds after 5000 ppm 2-ethylhexanol addition (B), and at 2 minutes after the 5000 ppm 2-ethylhexanol addition (C).

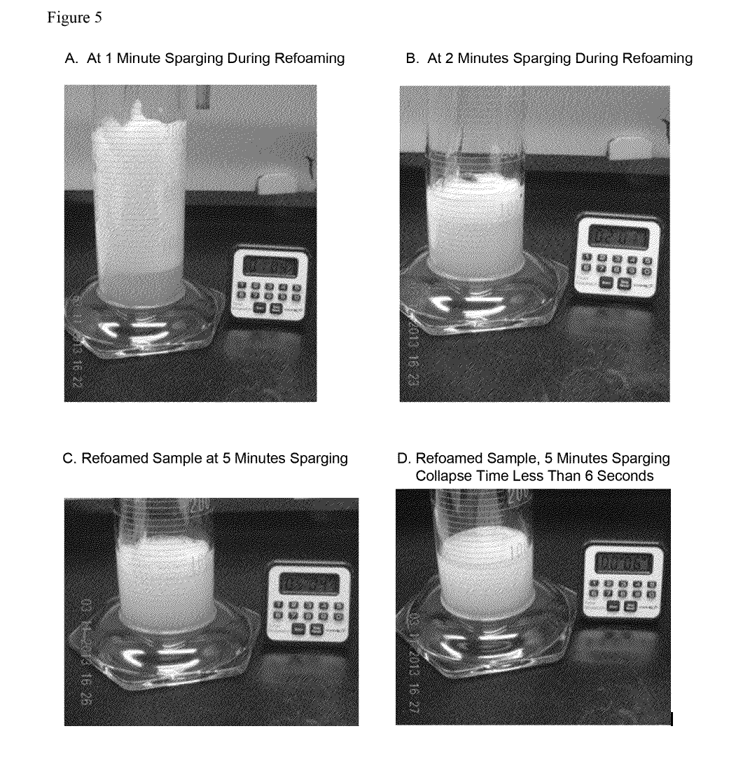

FIG. 5 shows results of an antifoam/refoam test using 100 mL brine, 5 mL condensate oil, and 5000 ppm alkyl betaine foamer with 5000 ppm 2-ethylhexanol defoamer after 1 minute of sparging during refoaming (A), 2 minutes of sparging during refoaming (B), the refoamed sample at 5 minutes sparging (C), and the refoamed sample after 5 minutes sparging, showing a collapse time of less than 6 seconds (D). The foam height decreased over time with continued agitation due to sparging on the sample treated with 5000 ppm 2-ethylhexanol. This is a desirable antifoam characteristic, as antifoam performance often degrades with continued sparging.

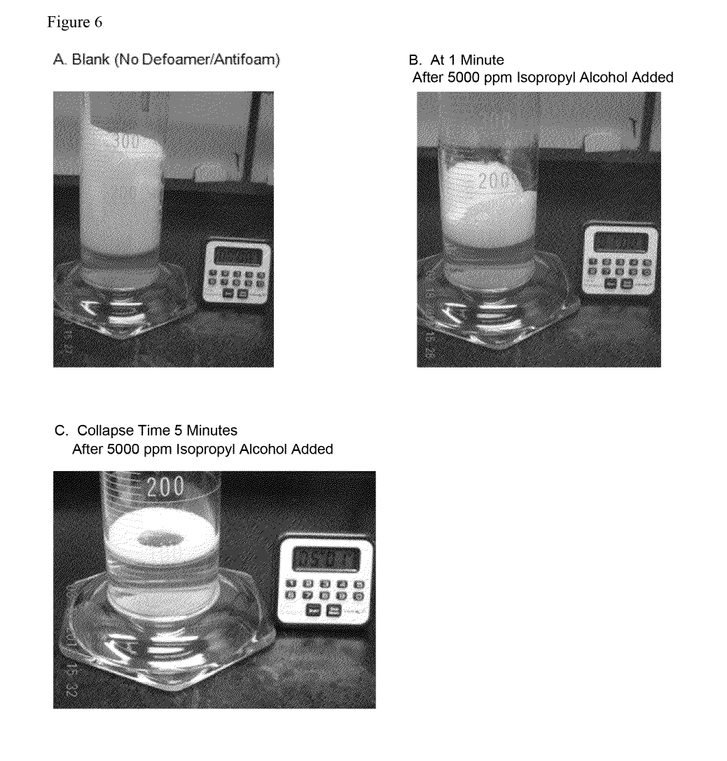

FIG. 6 shows results of the defoamer test using 100 mL brine, 5 mL condensate oil, and 5000 ppm of an alkyl betaine blend foamer, at an initial time (A), after 1 minute after 5000 ppm isopropyl alcohol addition (B), and at 5 minutes after the 5000 ppm isopropyl alcohol addition (C). The isopropyl alcohol showed foam knock down, but was not as effective as 2-ethyl hexanol.

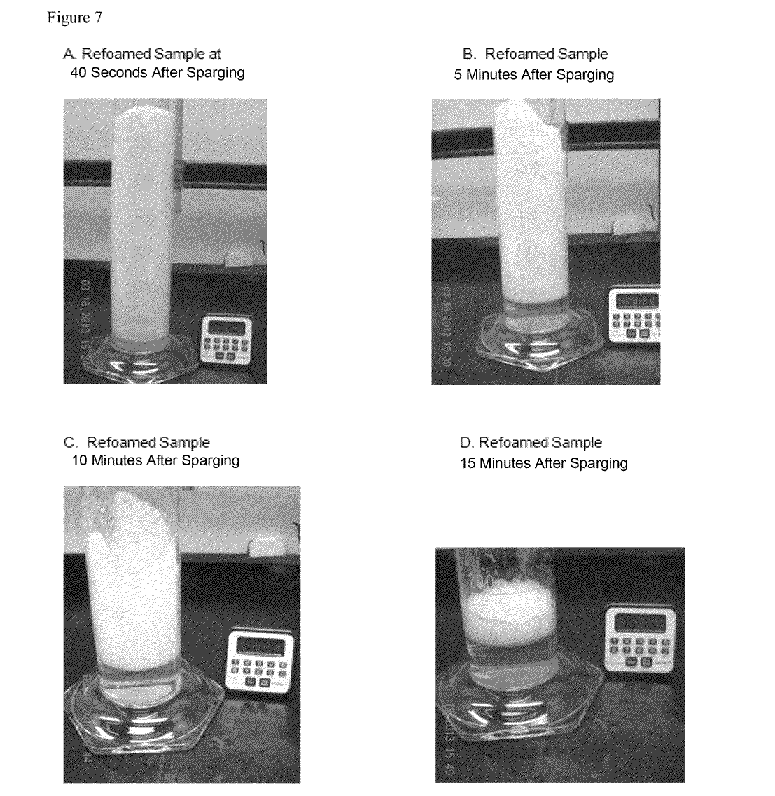

FIG. 7 shows results of an antifoam/refoam test using 100 mL brine, 5 mL condensate oil, and 5000 ppm alkyl betaine foamer with 5000 ppm isopropyl alcohol defoamer, 40 seconds after sparging (A), 5 minutes after sparging (B), 10 minutes after sparging (C), and 15 minutes after sparging (D). Isopropyl alcohol was not effective in preventing refoaming.

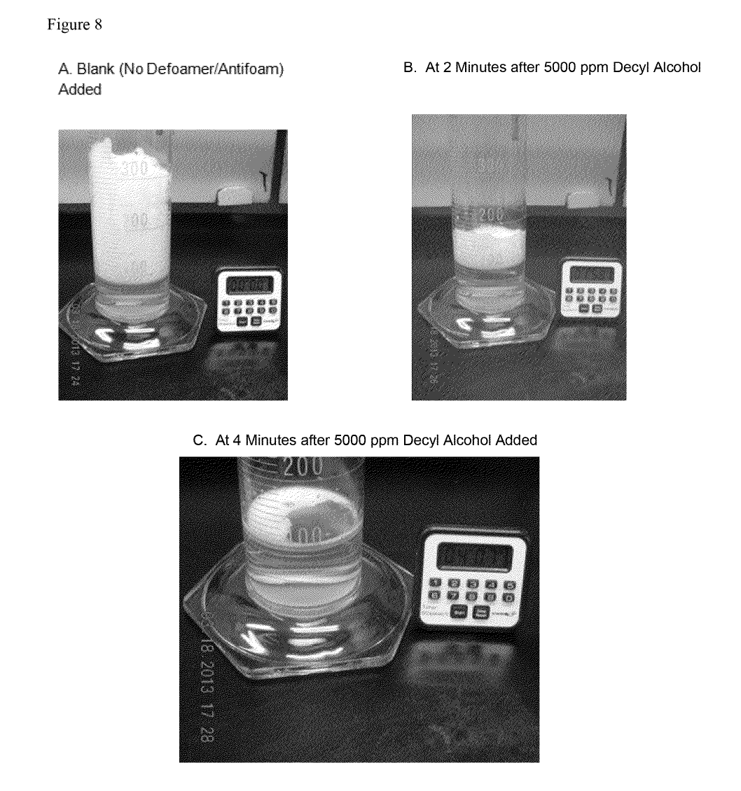

FIG. 8 shows results of the defoamer test using 100 mL brine, 5 mL condensate oil, and 5000 ppm alkyl betaine foamer, at an initial time (A), at 2 minutes after 5000 ppm decyl alcohol (alcohols, C₉-C₁₁-ISO, C₁₀-rich) addition (B), and at 4 minutes after the 5000 ppm decyl alcohol addition (C). The decyl alcohol is effective on foam knock down, but was not as effective as 2-ethyl hexanol.

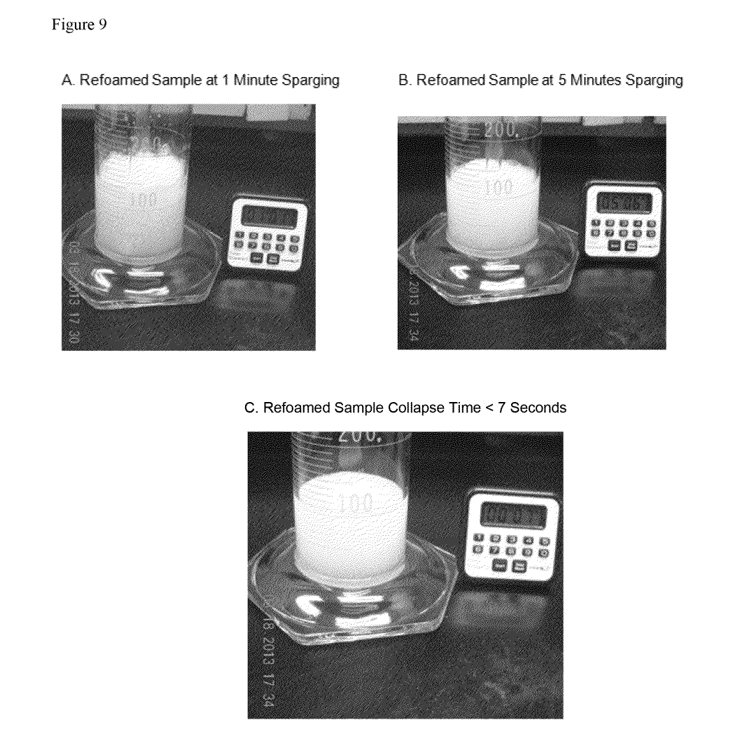

FIG. 9 shows results of an antifoam/refoam test using 100 mL brine, 5 mL condensate oil, and 5000 ppm alkyl betaine foamer with 5000 ppm decyl alcohol (alcohols, C₉-C₁₁-ISO, C₁₀-rich) defoamer, showing the refoamed sample at 1 minute sparging (A), the refoamed sample at 5 minutes sparging (B), and the refoamed sample collapse time of less than 7 seconds (C). Decyl alcohol was effective in preventing refoaming, similar to 2-ethylhexanol.

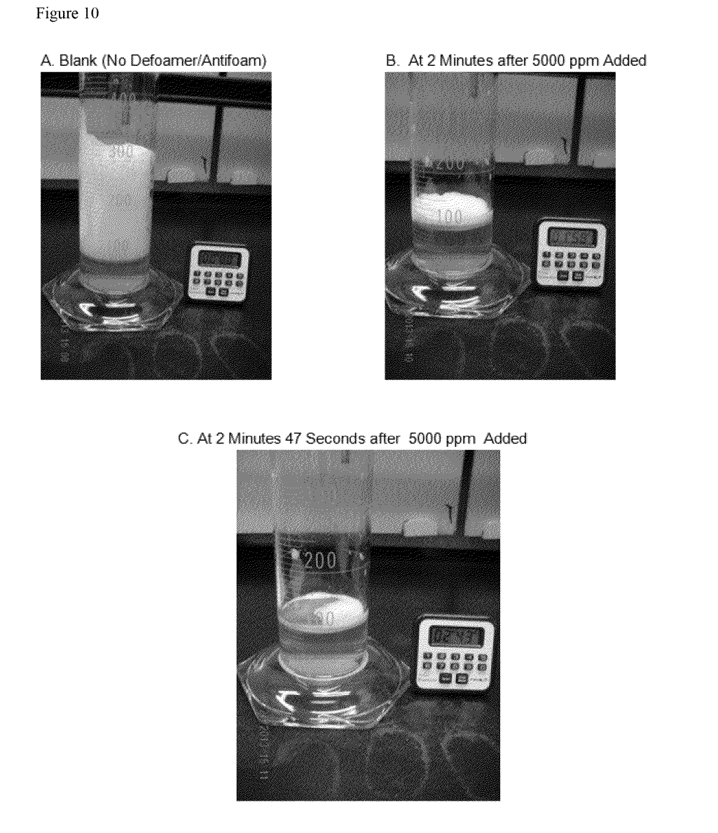

FIG. 10 shows results of the defoamer test using 100 mL brine, 5 mL condensate oil, and 5000 ppm alkyl betaine foamer, at an initial time (A), at 2 minutes after 5000 ppm addition of a mixture of 2-ethylhexanol+5 wt % 1-octadecanol (B), and at 2 minutes 47 seconds after the 5000 ppm addition of the mixture of 2-ethylhexanol+5 wt % 1-octadecanol (C).

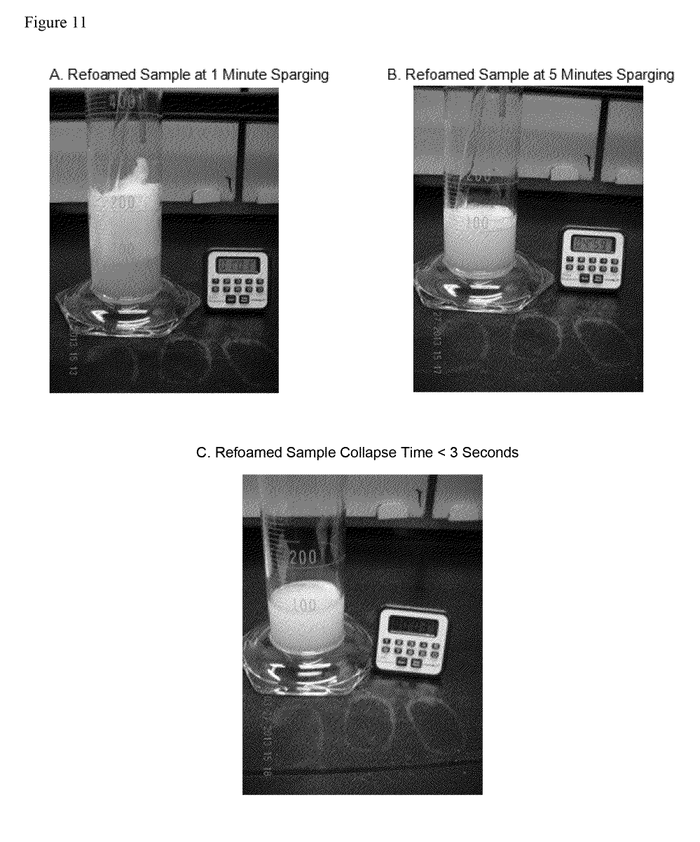

FIG. 11 shows results of an antifoam/refoam test using 100 mL brine, 5 mL condensate oil, and 5000 ppm alkyl betaine foamer with 5000 ppm of a mixture of 2-ethylhexanol+5 wt % 1-octadecanol, showing the refoamed sample at 1 minute sparging (A), the refoamed sample at 5 minutes sparging (B), and the refoamed sample collapse time of less than 3 seconds (C).

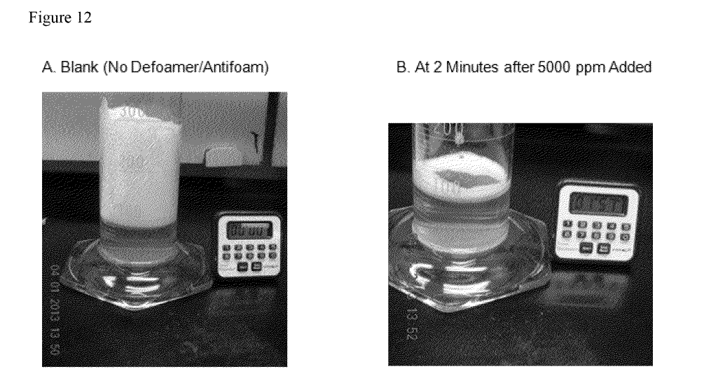

FIG. 12 shows results of the defoamer test using 100 mL brine, 5 mL condensate oil, and 5000 ppm alkyl betaine foamer, at an initial time (A), and at 2 minutes after addition of 5000 ppm of a 50/50 wt/wt mixture of 2-ethylhexanol and decyl alcohol (B).

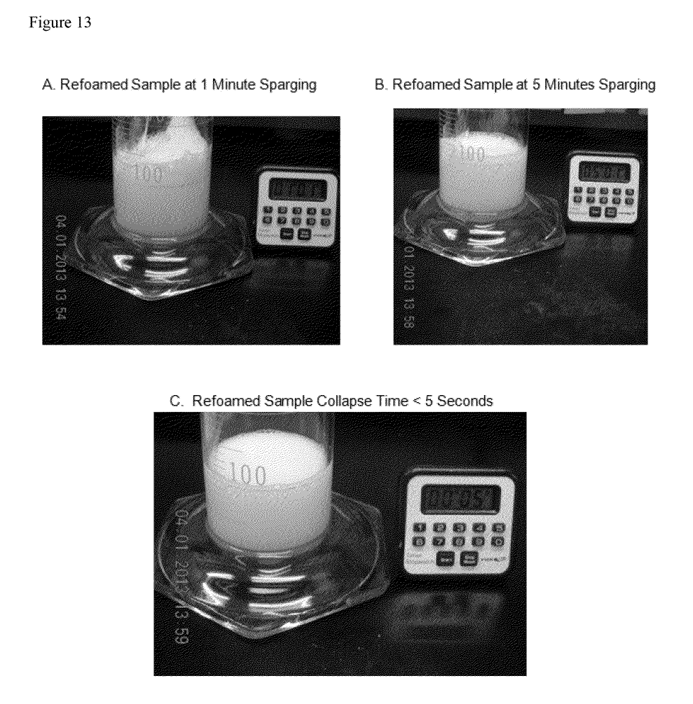

FIG. 13 shows results of an antifoam/refoam test using 100 mL brine, 5 mL condensate oil, and 5000 ppm alkyl betaine foamer with 5000 ppm of a 50/50 wt/wt mixture of 2-ethylhexanol and decyl alcohol, showing the refoamed sample at 1 minute sparging (A), the refoamed sample at 5 minutes sparging (B), and the refoamed sample collapse time of less than 5 seconds (C).

Table 1 below summarizes the defoamer/antifoam test results on the various alcohols and alcohol mixtures using the modified ASTM D892 Test.

TABLE 1
Defoamer/Antifoam (D/A) Test Results on 2-Ethylhexanol and
Additional Alcohols and Blends

| | | | | Refoam | Refoam | |
|---|---|---|---|---|---|---|
| | | | Collapse Time | Height | Height @ | Collapse Time |
| Test | D/A | ppm | from 300 mL | @ 1 Minute | 5 Minutes | After Refoam |
| 1 | Blank | 0 | >15 Minutes | — | — | — |
| | | | (from 650 mL) | | | |
| 2 | Blank | 0 | >10 Min | — | — | — |
| 3 | 2- | 5000 | 2 Minutes | 350 mL | 120 mL | <6 Seconds |
| | Ethylhexanol | | | | | |
| 4 | Isopropyl | 5000 | 5 Minutes | 700 mL @ | 550 mL | >15 Minutes |
| | Alcohol | | | 40 Seconds | | |
| 5 | Decyl | 5000 | 4 Minutes | 150 mL | 120 mL | <7 Seconds |
| | Alcohol | | | | | |
| 6 | 2- | 5000 | 2 Minutes | 230 mL | 120 mL | <3 Seconds |
| | Ethylhexanol + | | 43 Seconds | | | |
| | 5 wt % 1- | | | | | |
| | Octadecanol | | | | | |
| 7 | 2- | 5000 | 2 Minutes | 140 mL | 120 mL | <5 Seconds |
| | Ethylhexanol + | | | | | |
| | Decyl | | | | | |
| | Alcohol | | | | | |
| | (50/50, | | | | | |
| | wt/wt) | | | | | |

1. A method for defoaming a foam, the method comprising contacting the foam with an effective amount of a composition comprising a compound having the following formula: 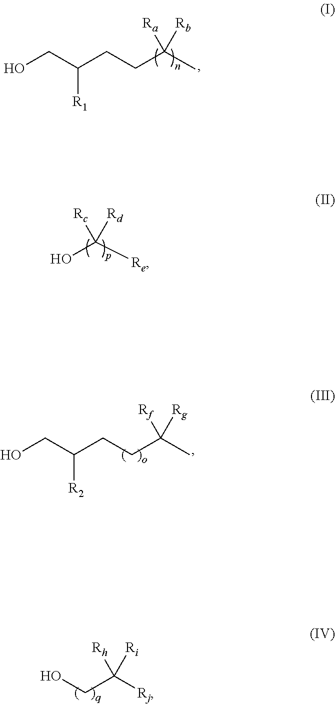
A mixture thereof, a blend thereof or a salt thereof, wherein
R₁ and R₂ are each independently selected from the group consisting of hydrogen and alkyl;
Rₐ, R_{b}, R_{F} and R_{g}, at each occurrence, are each independently selected from the group consisting of hydrogen and alkyl;
R_{c}, R_{d}, Rₕ and Rᵢ, at each occurrence, are each independently selected from the group consisting of hydrogen and methyl;
Rₑ and Rⱼ are hydrogen;
n and o are each independently 1, 2, 3, 4, 5, 6, 7, 8, 9, 10, 11, 12, 13, 14, or 15;
p is 1, 2, 3, or 4; and
q is 0, 1, 2, or 3.

2. The method of claim 1, wherein the composition does not contain silicon.

3. The method of claim 1, wherein the composition is contacted with the foam at the surface.

4. The method of claim 1, wherein the composition is injected into the foam.

5. The method of claim 1, wherein the composition comprises 2-ethylhexanol, decanol, or a mixture thereof.

6. The method of claim 1, wherein the composition comprises a mixture of about 95 wt % 2-ethylhexanol and about 5 wt % 1-octadecanol.

7. A method for inhibiting formation of a foam in an aqueous solution, the method comprising contacting the foam with an effective amount of a composition comprising a compound having the following formula: 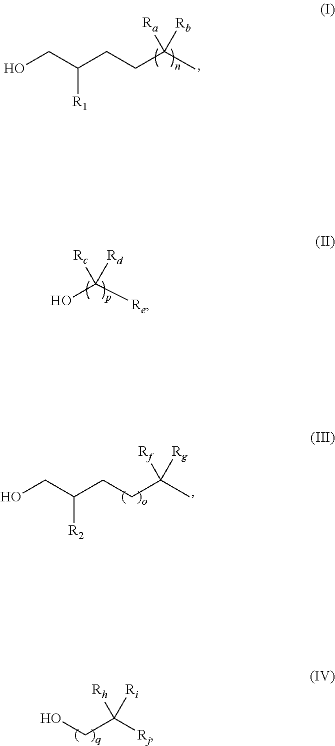
a mixture thereof, a blend thereof or a salt thereof, wherein
R₁ and R₂ are each independently selected from the group consisting of hydrogen and alkyl;
Rₐ, R_{b}, R_{f} and R_{g}, at each occurrence, are each independently selected from the group consisting of hydrogen and alkyl;
R_{c}, R_{d}, Rₕ and Rᵢ, at each occurrence, are each independently selected from the group consisting of hydrogen and methyl;
Rₑ and Rⱼ are hydrogen;
n and o are each independently 1, 2, 3, 4, 5, 6, 7, 8, 9, 10, 11, 12, 13, 14, or 15;
p is 1, 2, 3, or 4; and
q is 0, 1, 2, or 3.

8. The method of claim 7, wherein the composition does not contain silicon.

9. The method of claim 7, wherein the composition is contacted with the foam at the surface.

10. The method of claim 7, wherein the composition is injected into the foam.

11. The method of claim 7, wherein the composition comprises 2-ethylhexanol, decanol, or a mixture thereof.

12. The method of claim 7, wherein the composition comprises a mixture of about 95 wt % 2-ethylhexanol and about 5 wt % 1-octadecanol.

13. A method for relieving or preventing liquid backpressure in a well or pipeline, the method comprising
a. injecting into a well or pipe-line, a foam-forming composition, and optionally a gas, to produce a foam;
b. bringing the foam to a surface of the well or pipe-line; and
c. contacting the foam with an effective amount of a defoaming composition comprising a compound having the following formula: 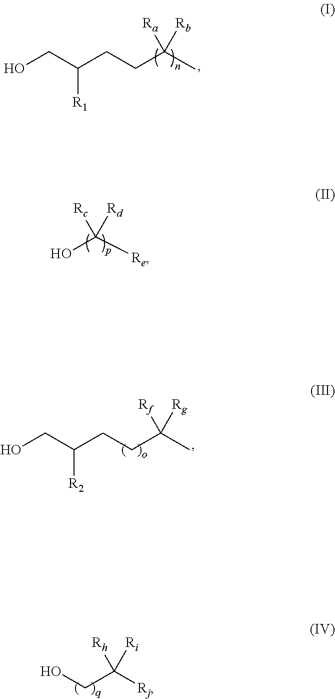
a mixture thereof, a blend thereof or a salt thereof, wherein
R₁ and R₂ are each independently selected from the group consisting of hydrogen and alkyl;
Rₐ, R_{b}, R_{f} and R_{g}, at each occurrence, are each independently selected from the group consisting of hydrogen and alkyl;
R_{c}, R_{d}, Rₕ and Rᵢ, at each occurrence, are each independently selected from the group consisting of hydrogen and methyl;
Rₑ and Rⱼ are hydrogen;
n and o are each independently 1, 2, 3, 4, 5, 6, 7, 8, 9, 10, 11, 12, 13, 14, or 15;
p is 1, 2, 3, or 4; and
q is 0, 1, 2, or 3,
wherein the defoaming composition breaks the foam and relieving liquid backpressure in a well or pipeline.

14. The method of claim 13, further comprising separating water from oil in the broken foam.

15. The method of claim 13, further comprising separating contaminants from gas and/or oil in the broken foam.

16. The method of claim 13, wherein the defoaming composition is contacted with the foam at the surface of the foam.

17. The method of claim 13, wherein the defoaming composition is injected into the foam.

18. The method of claim 13, wherein the defoaming composition comprises 2-ethylhexanol, decanol, or a mixture thereof.

19. The method of claim 13, wherein the defoaming composition comprises a mixture of about 95 wt % 2-ethylhexanol and about 5 wt % 1-octadecanol.
